(19) United States
(12) Patent Application Publication
(10) Pub. No.: US 2018/0320368 A1
(43) Pub. Date: Nov. 8, 2018

(54) THERMAL INSULATING CONSTRUCTION WRAP AND METHODS FOR SAME

(71) Applicants: Miguel Gonzales, Pearsland, TX (US); Lei Zhou, Sammanish, WA (US)

(72) Inventors: Miguel Gonzales, Pearsland, TX (US); Lei Zhou, Sammanish, WA (US)

(21) Appl. No.: 15/971,948

(22) Filed: May 4, 2018

Related U.S. Application Data
(60) Provisional application No. 62/502,397, filed on May 5, 2017.

(51) Int. Cl. E04B 1/78; E04B 1/76; B32B 37/12; B32B 9/00; B32B 3/26

(52) U.S. Cl. CPC E04B 1/78; E04B 1/762; B32B 2419/00; B32B 9/005; B32B 3/266; B32B 37/12

(57) ABSTRACT

A thermal insulating construction wrap includes a pliable substrate film. The pliable substrate film is impermeable to at least water and includes an exterior face and an interior face. An aerogel insulating layer is coupled along one or more faces of the pliable substrate film.

### CLAIM OF PRIORITY

This patent application claims the benefit of priority of Gonzales et. al., U.S. Provisional Patent Application Ser. No. 62/502,397 entitled “THERMIAL INSULATING CONSTRUCTION WRAP AND METHODS FOR SAME” filed on May 5, 2017 (Attorney Docket No. 3458.044PRV) which is hereby incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright R.H. Tamlyn & Sons, LP; Stafford, Tex., USA. All Rights Reserved.

### TECHNICAL FIELD

This document pertains generally, but not by way of limitation, to construction wraps applied as barriers to buildings.

### BACKGROUND

When constructing buildings (e.g., homes, offices or the like) a moisture barrier is, in some examples, used on the exterior of the building. For instance, a house or construction wrap (herein a construction wrap) is applied over the plywood or other exterior material of the building. The construction wrap encloses plywood, framing, insulation and other components of the building and minimizes water intrusion. External fascia, such as brick, stone, siding, stucco or the like, are applied over the construction wrap to provide a decorative exterior to the building. Water intrusion through the external fascia is intercepted by the construction wrap and diverted away from the covered components of the building.

Construction wrap, in some examples includes a pliable polymer that is wrapped around the features of the building including, but not limited to, walls, corners, fenestration openings (openings for doors or window), vent openings or the like. One example of a construction wrap is Tamlyn Wrap, a registered trademark of R.H. Tamlyn & Sons, LP.

### OVERVIEW

The present inventors have recognized, among other things, that a problem to be solved can include increasing the heating and cooling efficiency of a building. In some examples, the framing of a building is constructed in a consistent, often building code mandated, manner. The building frame is covered with an exterior sheathing such as plywood, and is then filled with insulation (e.g., fiberglass insulation whether rolled or blown). Increasing the thermal resistance of the building (e.g., an overall R-value) requires one or more of the use of better and more expensive grades of insulation, the use of thicker insulation with framing having greater depth (and corresponding expense and labor) or both. Each of these options require, in some examples, one or more of additional labor, premium materials or the like.

In other examples, for instance with piping, utility housings or the like, aerogel boards and blankets are installed and provide insulation. An aerogel is a porous material derived from a gel wherein the liquid component of the gel is replaced with a gas. The aerogel is a solid having extremely low density and low thermal conductivity (and conversely a high thermal resistance or R-value). The aerogel is applied as a planar sheet or board, or with gentle (large radius) bends to minimize fracture of the aerogel. Sharp corners and bends precipitate fractures in the aerogel and in some examples expose at least portions of the underlying piping, housing or the like to environmental conditions including extremes of heat and cold. The thermal insulating properties of the aerogel are thereby reduced or obviated.

The present subject matter provides a solution to these problems, such as by a thermal insulating construction wrap that includes an aerogel insulating layer coupled with a pliable substrate film. The aerogel insulating layer includes an aerogel having a high thermal resistance. The aerogel insulating layer is bonded to a pliable substrate film that minimizes (e.g., minimizes or eliminates) water intrusion through the film. Further, the pliable substrate film facilitates the wrapping of the construction wrap including the aerogel insulating layer around nearly any component including sharp corners, bends or the like commonly found when wrapping a building with construction wrap. For instance, the aerogel insulating layer is relatively brittle and as the construction wrap is folded around corners, into fenestration openings or the like the pliable substrate film retains the aerogel along the film and accordingly minimizes fractures or breaks in the insulation otherwise found with sharply folded aerogel blankets or boards. Further, even with breaking of the aerogel (e.g., with wrapping, folding, creasing or the like) the aerogel insulating layer is retained along the pliable substrate film to minimize gaps and localize fractures at corners, bends or the like. In other examples, the aerogel insulation layer is constructed with flexible aerogels including, but not limited to, liquid-phase and vapor-phase crosslinked aerogels, fiber reinforced aerogels and reduced bonded aerogels. In these examples, the aerogel insulation layer is relatively more pliable and better conforms to sharp corners and bends, and is further assisted with conforming by the pliable substrate film.

This overview is intended to provide an overview of subject matter of the present patent application. It is not intended to provide an exclusive or exhaustive explanation of the disclosure. The detailed description is included to provide fiurther information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a perspective view of a building enveloped with one example of a thermal insulating construction wrap.

FIG. 2 is a perspective view of a roll of the thermal insulating construction wrap of FIG. 1.

FIG. 3 is a schematic view of a wall with another example of the thermal insulating construction wrap installed thereon.

FIG. 4A is a cross sectional view of a first example of a thermal insulating construction wrap.

FIG. 4B is a cross sectional view of a second example of a thermal insulating construction wrap.

FIG. 4C is a cross sectional view of a third example of a thermal insulating construction wrap.

FIG. 4D is a cross sectional view of a fourth example of a thermal insulating construction wrap.

FIG. 4E is a cross sectional view of a fifth example of a thermal insulating construction wrap.

FIG. 4F is a cross sectional view of a sixth example of a thermal insulating construction wrap.

FIG. 4G is a cross sectional view of a seventh example of a thermal insulating construction wrap.

FIG. 5 is a schematic diagram showing one example of a production assembly for a thermal insulating construction wrap.

FIG. 6 is a block diagram showing one example of a method for making a thermal insulating construction wrap.

### DETAILED DESCRIPTION

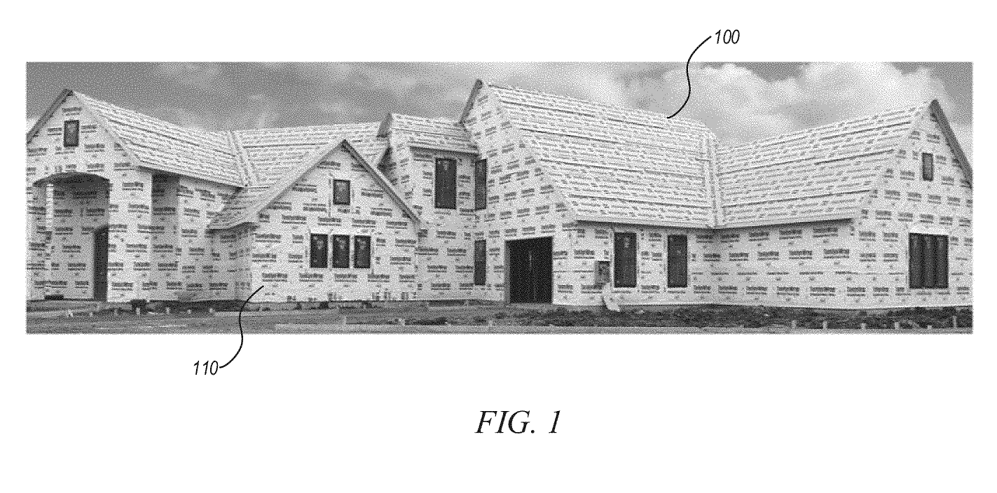

FIG. 1 is a perspective view of a building 100 enveloped with one example of a thermal insulating construction wrap 110. The thermal insulating construction wrap 110 insulates the building 100 (e.g., single family residential homes, multi-family residential units, municipal buildings, office buildings, or the like) from the surrounding environment (e.g., the elements of nature including but not limited to, moisture, heat, cold or the like). For example, the thermal insulating construction wrap 110 thermally insulates the building 100 from the environment, and increases the overall R-value (e.g., thermal resistance) of the building 100. In some examples, the thermal insulating construction wrap 110 is used in combination with additional insulation techniques (e.g., fiberglass insulation, spray foam insulation, foam board insulation, or the like) to enhance the environmental isolation of the building 100 relative to the surrounding environment, including enhancing the benefit of other types of insulation. Further, and as described in greater detail herein, the thermal insulating construction wrap 110 helps resist the infiltration of moisture (e.g., liquid water or humidity) into the building 100.

In an example, the thermal insulating construction wrap 110 is coupled to the building 100 (e.g., installed over, around or the like). The thermal insulating construction wrap 110 is coupled to an exterior surface of the building 100, including, but not limited to, wall panels, roof panels of the building 100 or the like. The thermal insulating construction wrap 110 pliably conforms to (e.g., comply with the contours) of the building 100. For example, the thermal insulating construction wrap 110 is adapted to pliably conform to corners, bends, fenestration openings (e.g., proximate windows and doors of the building 100) while maintaining the insulation performance (and moisture resistance) of the thermal insulating construction wrap 110.

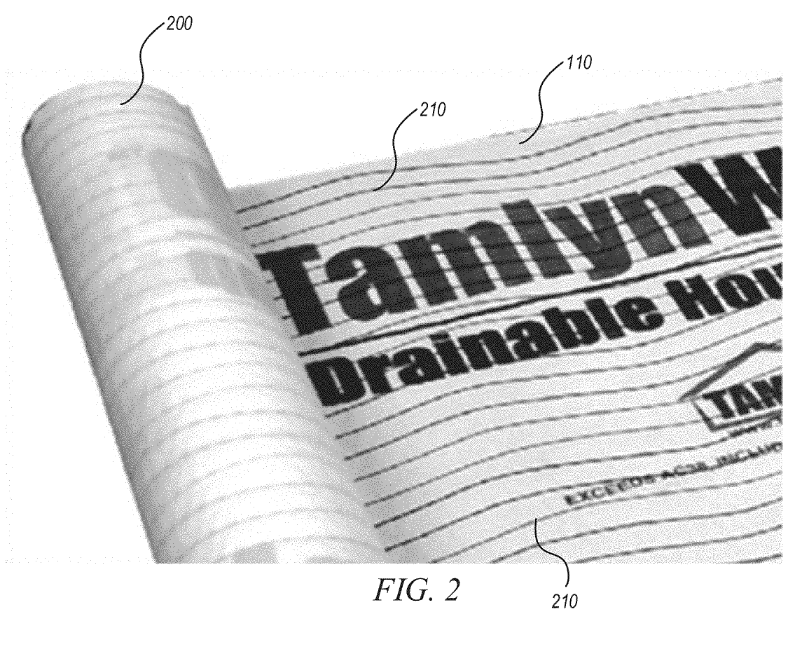

FIG. 2 is a perspective view of a roll 200) of the thermal insulating construction wrap 110 of FIG. 1. In the example shown, thermal insulating wrap 110 includes liquid diversion features 210. The liquid diversion features 210 divert liquids along thermal insulating wrap 110 and divert liquids away from the building 100 (shown in FIG. 1), for instance toward the exterior of the building while minimizing penetration to the walls and building interior. The water diversion features 210 include, but are not limited to, ridges; recesses; knurling; raised stippling; grooves; discontinuous ridges, recesses, grooves or the like provided on thermal insulating wrap 110. Liquid that penetrates a building exterior facia (e.g., stucco, shingles, siding, brick, pre-fabricated panels or the like) flows along the water diversion features 210 and is diverted away from the building 100. As shown in FIG. 2, in an example, the water diversion features 210 extend along a length of thermal insulating wrap 110. In some examples, the water diversion features 210 extend at an angle (e.g., are perpendicular, orthogonal, angled or the like) with respect to, the length of thermal insulating wrap 110. In still other examples, the water diversion features are arranged in one or more patterns including, but not limited to, lines, undulating lines (e.g., waves), herringbone patterns, or the like. Optionally, the water diversion features 210 are constructed with, but not limited to, polymers, rubber or the like and coupled with the thermal construction wrap 110. In other examples, the water diversion features 210 are formed with the thermal construction wrap 110, and are integral to one or more of the layers.

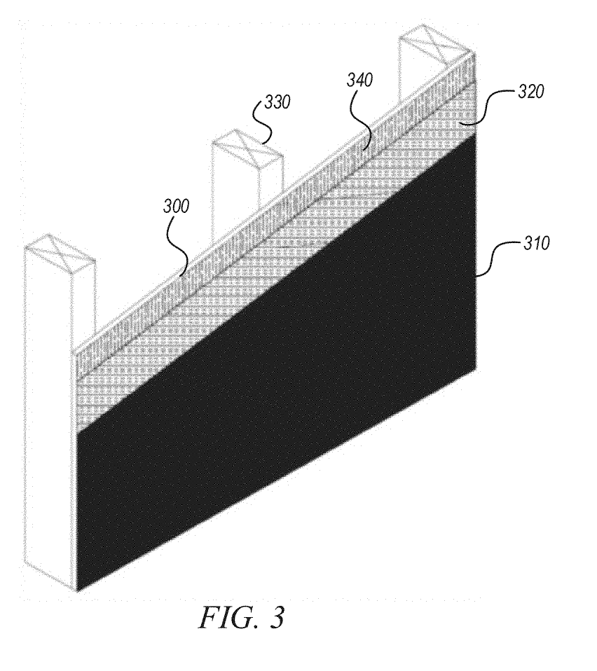

FIG. 3 is a schematic view of a wall panel 300 with another example of the thermal insulating wrap 110 installed thereon. The thermal insulating wrap 110 includes a pliable substrate film 310 and an insulating layer 320, for instance an aerogel insulating layer 320. The aerogel insulating layer 320 is coupled to (e.g., bonded to, adhered or the like) the pliable substrate film 310, and the pliable substrate film 310 facilitates the pliable conformity of thermal insulating wrap 110. In some examples, the aerogel insulating layer 320 is relatively brittle and fractures when deformed (e.g., rolled, bent, creased, or the like). The pliable substrate film 310 localizes fracturing of the aerogel insulating layer 320, and thereby improves the performance (e.g., thermal insulation characteristics) of thermal insulating wrap 110 by maintaining the integrity of the aerogel insulating layer 320. For instance, the aerogel insulating layer 320, even when fractured, maintains its location along the pliable substrate firm 310 without falling away from thermal insulating wrap 110, shedding or the like.

As described herein, thermal insulating wrap 110 is coupled to the building 100. For example, and as shown in FIG. 3, thermal insulating wrap 110 is coupled to the wall panel 300 that is included in the building 100 (shown in FIG. 1). The wall panel 300 is coupled with a framing member 330 (e.g., a wall stud, a roof truss, or the like) of the building 100. The wall panel 300 includes a panel exterior surface 340 that faces the surrounding (e.g., outdoor) environment. The coupling of thermal insulating wrap 110 to the wall panel 300 protects the panel exterior surface 340 from the surrounding environment. The aerogel insulating layer 320 is, in an example, provided on an interior face of the pliable substrate film 310. Accordingly, when thermal insulating wrap 110 is coupled to the wall panel 300, the aerogel insulating layer 320 is interposed between (e.g., positioned or sandwiched between) at least one pliable substrate film 310 and the panel exterior surface 340. The coupling of thermal insulating wrap 110 to the wall panel 300 insulates and protects the wall panel 300, and a building (for instance, the building 100 shown in FIG. 1), from the surrounding environment by providing the aerogel insulating layer 320 and the pliable substrate film 310.

A variety of materials for both the aerogel insulating layer 320 and the pliable substrate film 310 are used in the various examples of the thermal insulating construction wrap 110. For instance, the pliable substrate film 310 includes one or more materials, such as polymers. In some examples, the pliable substrate film 310 includes, but is not limited to, one or more of thermoplastic polyolefins; single layer, non-woven, laminate or woven polypropylene; high density polyethylene (HDPE) (e.g., spunbond HDPE); micro-perforated, cross-lapped films; films laminated to spunbond nonwovens; films laminated or coated to polypropylene wovens; supercalendered, wetlaid polyethylene fibril nonwoven (e.g., Tyvek, a registered trademark of E.I. DuPont de Nemours and Co. of Wilmington, Del.); reflective aluminum foil; cross-linked polymer films and a layer of rubberized asphalt; composites of polymers; recycled materials; and composites including laminates of the same.

In other examples, the aerogel insulating layer 320 includes, but is not limited to, one or more of crosslinked aerogels such as wet silica gel soaked in solutions such as a diisocyanates that are heated to bond the diisocyanates; polyisocyanates; epoxides; polystyrene or the like. Optionally, amine functional groups are used to bond polymers to the gel. For instance, 3-aminopropyltriethoxysilane (APTES) is added to the gel as it sets. APTES places amine functional groups (−NH2) over the surface of the gel in addition to hydroxyl groups. These amine groups are used to bond a variety of polymers to the framework of the aerogel insulating layer 320. For instance, the amine or other groups are used as an intermediate or adhesive layer to couple the aerogel insulating layer 320 with the pliable substrate wrap 310. In still other examples, polymer based aerogels are themselves cross linked (e.g., like braces) to enhance the strength of the aerogel insulating layer 320.

In still other examples, organic or inorganic materials such as microfibers, filaments, fibers, or the like are added to the aerogel insulating layer 320 to reinforce the aerogel (e.g., including enhancements to pliability and increased resistance to fracture). For instance, Nylon, glass fibers or the like are used as a substrate that receives the aerogel thereon before drying. In one example, the aerogel (such as a silica aerogel) is applied to a fibrous batting (a porous, flexible fiber mat). The liquid of the composite aerogel insulating layer is supercritically dried to produce reinforced aerogels. For instance, the liquid of the layer 320 is supercritically cooled (e.g., freeze dried) at low temperatures and low pressures relative to a liquid and gas transition curve of the aerogel liquid to avoid the liquid-gas boundary of the aerogel (and potential damage caused by surface tension). In another example, the aerogel liquid of the aerogel insulating layer is supercritically heated (e.g., dried by heat) at high temperature and high pressure relative to the liquid and gas transition curve of the aerogel liquid.

In still other examples, polymers are added to aerogels to reinforce the aerogel insulating layer 320 (e.g., polymer reinforced silica aerogels). For instance, vapor deposition along aerogels provides enhanced strength including resistance to fracture, increased pliability or the like. For instance, an existing aerogel (dried) is treated with a polymer coating that infiltrates the pores of the aerogel. One or more of chemical vapor deposition (CVD) or atomic layer deposition (ALD) are used to apply a polymer coating, such as methyl cyanoacrylate, to the aerogel.

Optionally, the bonding between atoms of the aerogel are limited to enhance the aerogel flexibility (including pliability and correspondingly resistance to fracture). In some examples, a silica aerogel includes four-way bonds with other silicon atoms with intervening oxygen bridges. In other examples, bonding is limited to, for instance a three-way bond between adjacent silicon atoms with intervening oxygen bridges. The remaining fourth bond is instead bonded with a methyl group or other group but does not otherwise connect to other silicon atoms. The reduced bonding increases the flexibility of the aerogel insulating layer 320 and enhances its pliability to a degree closer to the pliable substrate film 310. Accordingly, the resilience and performance of thermal insulating wrap 110 is improved because the aerogel insulating layer 320 is adapted to withstand the stress and strain associated with coupling thermal insulating wrap 110 to the building 100 (shown in FIG. 1) including pliably deforming the wrap around corners, through openings or the like, relative to materials that are more prone to fracture (e.g., are brittle).

Further, methyl groups enhance the hydrophobicity (e.g., the ability to repel a liquid, such as water) of the aerogel insulating layer 320. In an example, the hydrophobic and flexible aerogel insulating layer 320 cooperates with the pliable substrate film 310 to increase the overall moisture resistance of the thermal insulating wrap 110.

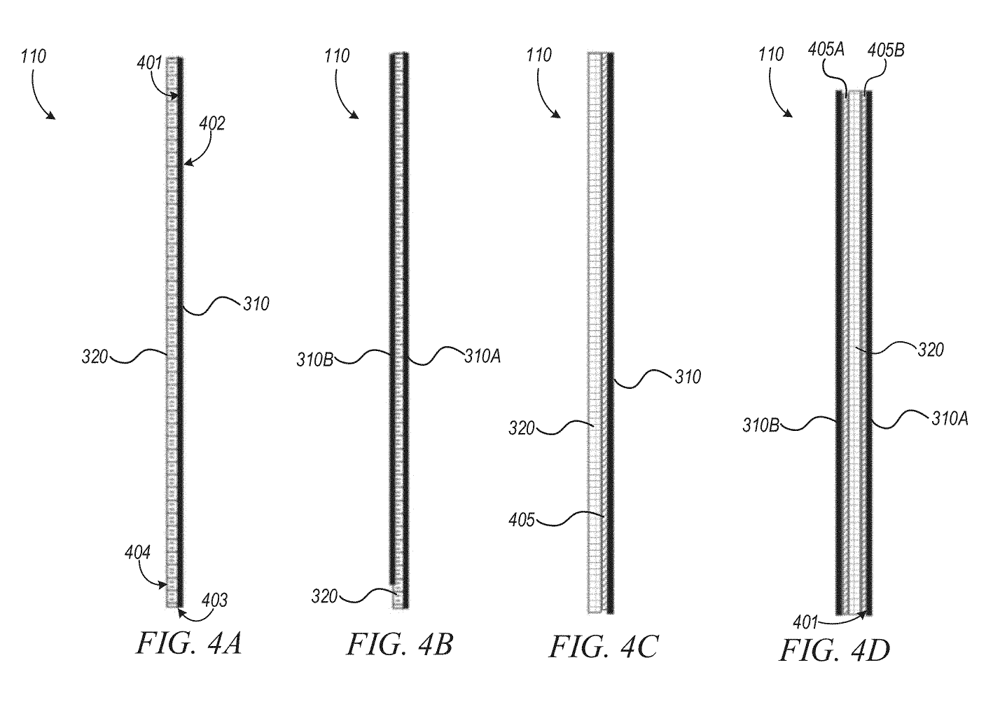

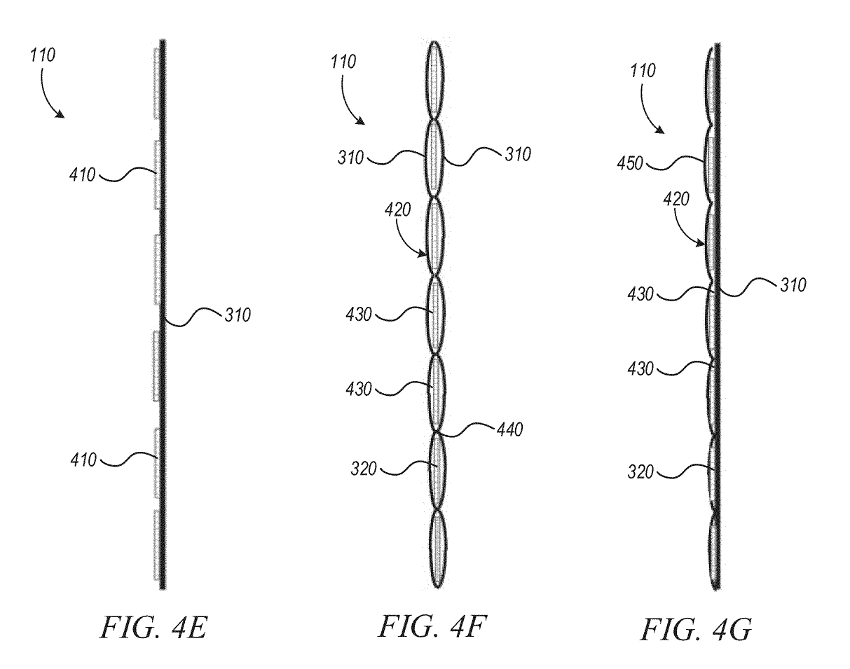

FIG. 4A is a cross sectional view of a first example of a thermal insulating construction wrap 110. Thermal insulating wrap 110 includes the pliable substrate film 310 and the aerogel insulating layer 320. The pliable substrate film 310 includes an interior face 401 (e.g., a first side) and an exterior face 402 (e.g., a second side). The pliable substrate film 310 is coupled to the aerogel insulating layer 320. For example, the interior face 401 of the pliable substrate film 310 is coupled to a first side 403 of the aerogel insulating layer 320, and a second side 404 of the aerogel insulating layer 320 is adapted to couple with a building (such as the building 100, shown in FIG. 1). In some examples, the coupling of the pliable substrate film 310 with the aerogel insulating layer 320 includes infiltration of the aerogel insulating layer 320, such as by melting into pores of the aerogel insulating layer 320. In other examples, coupling of the pliable substrate film 310 with the aerogel insulating layer 320 includes bonding of the film 310 to the aerogel insulating layer 320 (e.g., through adhesives, welds, bonding between the aerogel and film molecules or the like, for instance through heating).

FIG. 4B is a cross sectional view of a second example of a thermal insulating construction wrap 110. The thermal insulating wrap 110 includes the pliable substrate film 310 coupled to the aerogel insulating layer 320. In an example, a first pliable substrate film 310A is coupled to a first side of the aerogel insulating layer 320. A second pliable substrate film 310B is coupled to a second side of the aerogel insulating layer 320. Coupling the pliable substrate film 310 (including component films 310A, B) to two or more sides (including edges) of the aerogel insulating layer 320 isolates the aerogel insulating layer 320 and thereby provides additional protection to the aerogel, while also increasing moisture resistance for the thermal insulating construction wrap 110.

Additionally, coupling the pliable substrate film 310 to both sides of the aerogel insulating layer 320 simplifies installation of thermal insulating wrap 110 by allowing for installation of the thermal insulating wrap 110 in more than one orientation. For example, either of the first pliable substrate finlm 310A or the second substrate film 310B are applied to the exposed panel surface 340 while the other of the films 310B1, A is exterior facing and provides moisture resistance. In this example, the installer does not need to check the installation of the film to ensure the aerogel insulating layer 320 is interior relative to an exterior pliable substrate film because the thermal insulating construction wrap 110 in this example is reversible.

FIG. 4C is a cross sectional view of a third example of a thermal insulating construction wrap 110. In the example shown, the thermal insulating wrap 110 includes an adhesive layer 405. Optionally, the adhesive layer 405 enhances the coupling between the pliable substrate film 310 and the aerogel insulating layer 320, and thereby minimizes decoupling of the layers (e.g., separation or delamination).

In an example, the adhesive layer 405 is provided between the pliable substrate film 310 and the aerogel insulating layer 320. In another example, the adhesive layer includes one or more component adhesive layers. For instance, a first adhesive layer 405A is coupled with the pliable substrate film 310 and a second adhesive layer 405B is coupled with the aerogel insulating layer 320. The first adhesive layer 405A is bonded with the second adhesive layer 405B. For instance, a single adhesive layer 405 or multiple layers 405A, B are used in some examples to provide a bonding interface between the pliable substrate film 310 and the aerogel insulating layer 320 when the film and layer 320 do not readily bond.

In yet another example, the first adhesive layer 405A includes a first adhesive material and the second adhesive layer 405B includes a second adhesive material Optionally, the first adhesive material has increased bonding strength with the pliable substrate film 310 (e.g., polymers), and the second adhesive material has improved bonding strength with the aerogel insulating layer 320 (e.g., such as crosslinked aerogels). The first adhesive and the second adhesive help to bond disparate materials together and thereby improves the coupling of the pliable substrate film 310 with the aerogel insulating layer in contrast with using a single adhesive (e.g., only the first adhesive).

FIG. 4D is a cross sectional view of a fourth example of a thermal insulating construction wrap 110. In this example, the thermal insulating wrap 110 includes the first pliable substrate film 310A, the aerogel insulation layer 320, and the second pliable substrate film 310B. Additionally, the thermal insulating wrap 110 includes a first adhesive layer 405A positioned on a first side of the aerogel insulation layer 320 and a second adhesive layer 405B coupled to a second side of the aerogel insulation layer 320. In a similar manner to the thermal insulating construction wrap 110 shown in FIG. 4B, the insulating wrap 110 shown in FIG. 4D is reversible to facilitate installation.

FIG. 4E is a cross sectional view of a fifth example of a thermal insulating construction wrap 110. In this example, the aerogel insulating layer 320 is optionally less flexible (e.g., less pliable or more brittle). The aerogel is provided as aerogel slats 410 (e.g., strips, ribbons or the like) and retained along an interior face 401 of the pliable substrate film 310. Scoring, slits, gaps or the like (collectively, gaps) between the aerogel slats 410 facilitate the pliability of the wrap 110. For instance, the thermal insulating construction wrap 110 readily folds, creases, complies or the like at the gaps to ensure compliant application to the contours of a building. Optionally, the aerogel slats 410 are coupled with an intermediate film, substrate or adhesive (a base layer for the aerogel insulating layer 320) that prearranges the slats with specified gaps, and the intermediate film of the layer 320 is bonded with the pliable substrate film 310.

FIG. 4F is a cross sectional view of a sixth example of a thermal insulating construction wrap 110. In this example, the pliable substrate film 310, the aerogel insulating layer 320, or a combination thereof are included in a storage membrane 420 that includes a plurality of storage cells 430. The aerogel insulating layer 320 includes one or more of aerogel slats 410, aerogel filler or the like positioned within the storage cells 430. Optionally the aerogel insulating layer 320, coupled with the pliable substrate film 310 through the storage cells 430, is bonded with the storage membrane 420 (film 310), for instance with adhesives. In other examples, the aerogel insulating layer 320 is retained in the cells 430 and not otherwise bonded with the film 310. The gaps between the aerogel (e.g., edges of the storage cells 430) are relatively flexible and increase the pliability of the thermal insulating construction wrap 110 compared to sheets or boards of a base aerogel. During assembly, the aerogel slats 410 (or filler) are nested between layers of film (of the aerogel insulating layer 320, the pliable substrate film 310, or both) and a heat sealer, ultrasonic sealer, adhesive, or the like couples the layered film to create a film joint 440, while also forming the storage cells 430 with the aerogel therein.

FIG. 4G is a cross sectional view of a seventh example of a thermal insulating construction wrap 110. The thermal insulating wrap 110 includes an enclosure film 450 bonded to the pliable substrate film 310. The enclosure film 450 includes a polymer material. The enclosure film 450 is a storage membrane 420 that contains (e.g., holds or stores) one or more of aerogel slats 410, aerogel filler or the like positioned within the storage cells 430. The bonding of the enclosure film 450 to the pliable substrate film 310 forms the plurality of storage cells 430 that are adapted to enclose the aerogel insulating layer 320.

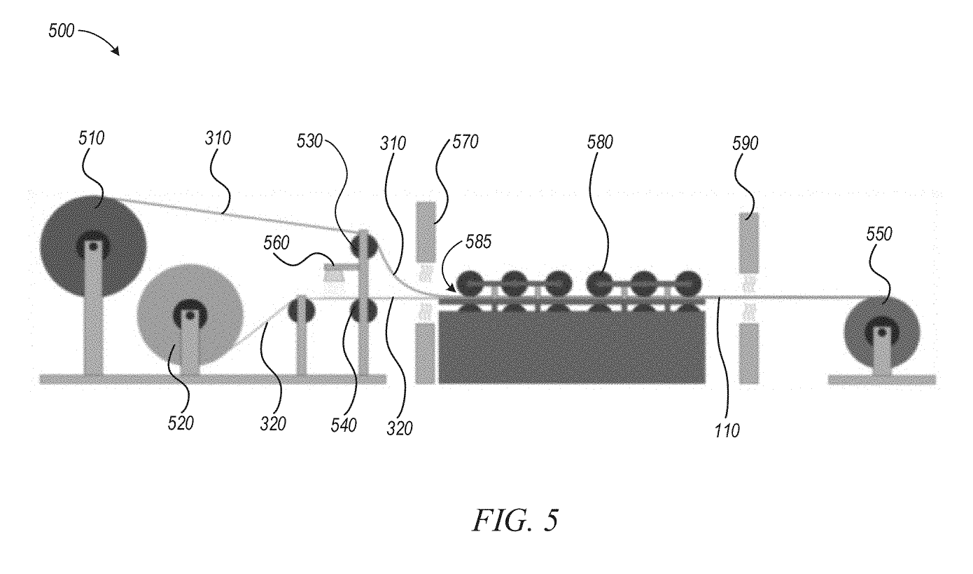

FIG. 5 is a schematic diagram showing one example of a production assembly 500 to assemble the thermal insulating construction wrap 110, including the various examples of the wrap described herein. The production assembly 500 includes a pliable substrate film spool 510 that includes the pliable substrate film 310 and includes an aerogel insulating layer spool 520 that includes the aerogel insulating layer 320. The aerogel insulating layer 320 is pliable in one example and adapted to be drawn or otherwise conveyed through the production assembly 500.

In other examples, the aerogel insulating layer 320 is less pliable, and is fed in sheets, slats or the like into the assembly 500 (e.g., from a magazine, hopper or the like).

In this example, the production assembly 500 includes film guide rollers 530 adapted to support or position the pliable substrate film 310. Additionally, the production assembly 500 includes layer guide rollers 540 adapted to support or position the aerogel insulating layer 320.

In an example, after processing with the production assembly 500, the thermal insulating construction wrap 110 is rolled onto a thermal insulating construction wrap spool 550 for transportation, storage, and installation. In some examples, the aerogel slats 410 (shown in FIGS. 4E-G) facilitate conformation of the thermal insulating wrap 110 to the thermal insulating construction wrap spool 550. Additionally, in an example, the storage cells 430 and the intervening gaps between slats, filler or the like facilitate conformation of the thermal insulating wrap 110 to the thermal insulating construction wrap spool 550.

In some examples, the production assembly 500 includes an adhesive applicator 560 positioned within the production assembly 500 that is adapted to apply an adhesive (e.g., the adhesive layer 405 of FIGS. 4C and 4D) to one or more of the pliable substrate film 310 or the aerogel insulating layer 320. The adhesive applicator 560 is positioned proximate one or more of the pliable substrate film 310 or the aerogel insulating layer 320 and dispenses the adhesive, bonding agent or the like to the pliable substrate film 310 or the aerogel insulating layer 320.

In some instances, the production assembly 500 includes a heating element 570. The heating element 570 operates through one or more of radiative, conductive, or convective modes of heat transfer and heats one or more of the pliable substrate film 310 or the aerogel insulating layer 320. In one example, heating of the pliable substrate film 310 or the aerogel insulating layer 320 enhances the bonding between the pliable substrate film 310 and the aerogel insulating layer 320. Optionally, the heating element 570 heats the pliable substrate film 310 or the aerogel insulating layer 320 before the pliable substrate film 310 is bonded with the aerogel insulating layer 320 In the example production assembly 500 shown in FIG. 5, the assembly includes a compression mechanism, such as a compression roller array 580 that provides a compressive nip 585. The pliable substrate film 310 and the aerogel insulating layer 320 are rolled between (e.g., fed into) the compressive nip 585 and the compression roller array compresses (e.g., apply a force to both) the pliable substrate film 310 and the aerogel insulating layer 320 between opposed compressive rollers. In other example, the compression mechanism includes opposed compression plates configured to compress the film 310 and the aerogel insulating layer 320 therebetween (e.g., where the thermal insulating construction wrap 110 is assembled in lineal sheets).

As described herein, and in some examples, the pliable substrate film 310 infiltrates the aerogel insulating layer 320 (e.g., the pores of the aerogel insulating layer 320). In an example, the compression roller array 580 includes one or more heating elements that are included in individual rollers of the compression roller array 580. The heated rollers heat one or more of the pliable substrate film 310 or the aerogel insulating layer 320 during the bonding process to help facilitate bonding of the pliable substrate film 310 with the aerogel insulating layer 320. In some instances, the heated rollers facilitate the bonding by activating the adhesive 405. In other examples, the heated rollers heat the pliable substrate film 310 to a melting temperature (or glass transition temperature), and the pliable substrate film 310 infiltrates into the pores of the aerogel insulating layer 320 upon compression at the compressive nip 585 between the rollers.

In an example, the production assembly includes a drying system 590 adapted to help finish the bonding of the pliable substrate film 310 with the aerogel insulating layer 320. The drying system 590 is adapted to administer heated or cooled air to the thermal insulating wrap 110. In some examples, the drying system 590 is controlled and varies the temperature applied to the thermal insulating wrap 110. Variation in drying (e.g., controlled cooling, staged cooling, staged heating or the like) tempers the thermal insulating wrap 110 and minimizes setting of either or both of the film 310 or the aerogel insulating layer 320 to facilitate winding around the thermal insulating construction wrap spool 550

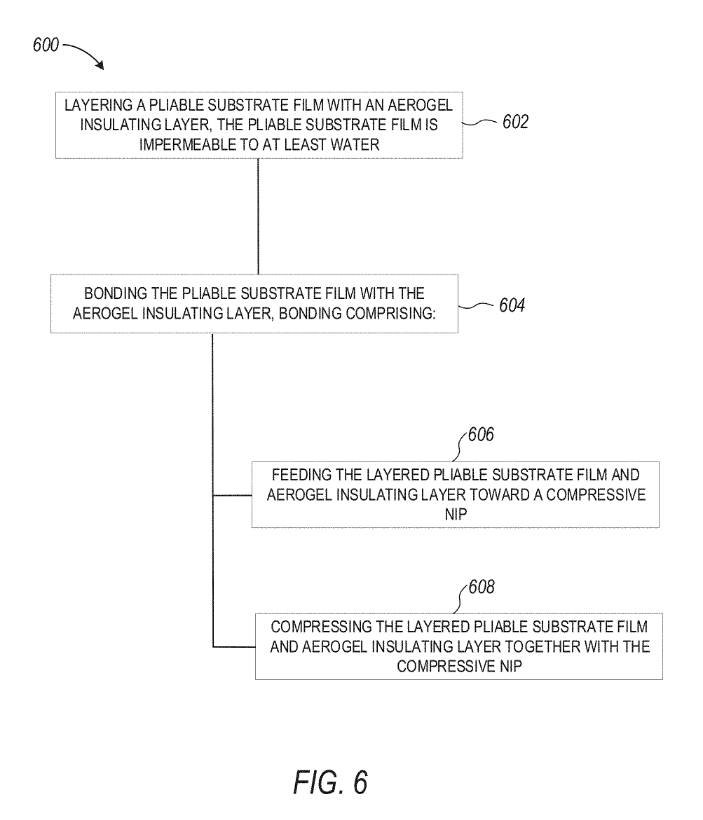

FIG. 6 shows one example of a method 600 for making thermal insulating construction wrap including one or more of the thermal insulating construction wrap examples described herein. In describing the method 600, reference is made to one or more components, features, functions or steps previously described herein. Where convenient, reference is made to the components, features, steps or the like with reference numerals. The reference numerals provided are exemplary and are not exclusive. For instance, components, features, functions, steps or the like described in the method 600 include, but are not limited to, the corresponding numbered elements provided herein and other corresponding elements described herein (both numbered and unnumbered) as well as their equivalents.

At 602, a pliable substrate film 310 is layered with an aerogel insulating layer 320. In an example, layering the pliable substrate film 310 with the aerogel insulating layer 320 includes layering the pliable substrate film 310 with a plurality of aerogel slats 410. In another example, layering the pliable substrate film 310 with the aerogel insulating layer 320 includes layering the pliable substrate film 310 with the aerogel insulating layer 320 including a storage membrane 420 having aerogel filler in a plurality of storage cells 430.

In yet another example, the pliable substrate film 310 includes an exterior substrate film and an interior substrate film (e.g., component films), and layering the pliable substrate film 310 with the aerogel insulating layer 320 includes layering the exterior substrate film with the aerogel insulating layer 320. Additionally, layering the pliable substrate film with the aerogel insulating layer includes layering the interior substrate film with the aerogel insulating layer 320, and the aerogel insulating layer 320 is between the exterior and interior substrate films.

At 604, the pliable substrate film 310 is bonded with the aerogel insulating layer 320. At 606, bonding includes feeding the layered pliable substrate film 310 and aerogel insulating layer 320 toward a compressive nip 585. At 608, bonding includes compressing the layered pliable substrate film 310 and aerogel insulating layer 320 together with the compressive nip 585 (e.g., with a compression mechanism including, but not limited to, compressive rollers, plates or the like).

In one example, the pliable substrate film 310 and the aerogel insulating layer 320 are laminated. Optionally, the pliable substrate film 310 is heated (e.g., to its melting point or glass transition temperature) and then laminated to the aerogel insulating layer 320. With pressure, for instance with the compressive nip 585 (e.g., rollers, plates or the like), the pliable substrate film 310 infiltrates pores of the aerogel insulating layer 320 to bond the film with the aerogel insulating layer 320. In still other examples, the aerogel insulating layer 320 is heated and the pliable substrate film 310 approaches its glass transition temperature when contacted to the heated aerogel insulating layer 320 (e.g., with the compressive nip 585).

In another example, the aerogel insulating layer 320 includes aerogel slats 410. Optionally, the layered pliable substrate film 310 and aerogel insulating layer 320 are compressed together (see the thermal insulation wrap 110 in FIG. 4E). In another option, compressing the pliable substrate film 310 and aerogel insulating layer 320 includes compressing exterior and interior substrate films together with the aerogel slats 410 therebetween (see FIGS. 4F, G). Additionally, bonding the pliable substrate film 310 with the aerogel insulating layer 320 and compressing the layered pliable substrate film 310 and aerogel insulating layer 320 includes forming storage cells 430 with the exterior and interior substrate films, and the aerogel slats 410 are within the storage cells 430.

In still other examples, the pliable substrate film 310 and the aerogel insulating layer 320 are coupled with an intermediate layer including, but not limited to, one or more of, an adhesive (e.g., the adhesive 405 of FIGS. 4C and 4D), a film configured to bond with each of the pliable substrate film 310 and the aerogel insulating layer 320 (e.g., where the film and layer do not readily bond with each other) or the like.

The pliable substrate film 310 and the aerogel insulating layer 320 are optionally wound onto a spool, provided in lineal sheets or the like for shipping, storage and installation. Optionally, the film 310 and the aerogel insulating layer 320 are fully bonded when wound onto the spool or stored in lineal sheets.

### VARIOUS NOTES & EXAMPLES

Example 1 includes subject matter such as a thermal insulating construction wrap comprising: a pliable substrate film, the pliable substrate film is resistant to at least water penetration, and the pliable substrate film includes: an exterior face, and an interior face; an aerogel insulating layer coupled along the interior face of the pliable substrate film; and wherein the thermal insulating construction wrap is pliable.

Example 2 can include, or can optionally be combined with the subject matter of Example 1, to optionally include an adhesive layer interposed between the interior face and the aerogel insulating layer.

Example 3 can include, or can optionally be combined with the subject matter of one or any combination of Examples 1 or 2 to optionally include wherein the pliable substrate film infiltrates the aerogel insulating layer to couple the aerogel insulating layer with the pliable substrate film.

Example 4 can include, or can optionally be combined with the subject matter of one or any combination of Examples 1-3 to optionally include wherein the pliable substrate film infiltrates pores of the aerogel insulating layer.

Example 5 can include, or can optionally be combined with the subject matter of one or any combination of Examples 1-4 to optionally include wherein the aerogel insulating layer includes a plurality of aerogel slats, and the plurality of aerogel slats are coupled along the interior face of the pliable substrate film with one or more of scoring or slits between each of the aerogel slats.

Example 6 can include, or can optionally be combined with the subject matter of Examples 1-5 to optionally include wherein the aerogel insulating layer includes: a storage membrane including a plurality of storage cells, the storage membrane coupled along the interior face of the pliable substrate film, and aerogel filler within the storage cells of the plurality of storage cells.

Example 7 can include, or can optionally be combined with the subject matter of Examples 1-6 to optionally include wherein the pliable substrate film includes: a storage membrane including a plurality of storage cells between the exterior and interior faces, and the aerogel insulating layer includes aerogel filler within the storage cells of the plurality of storage cells.

Example 8 can include, or can optionally be combined with the subject matter of Examples 1-7 to optionally include wherein the pliable substrate film includes one or more of thermoplastic polyolefin, laminate of woven polypropylene, high density polyethylene (HDPE), spunbond HDPE, micro-perforated and cross-lapped films, films laminated to spunbond nonwovens, films laminated or coated to polypropylene wovens, supercalendered wetlaid polyethylene fibril nonwoven, reflective aluminum foil, cross-linked polymer films, a layer of rubberized asphalt, or composites of polymers and recycled materials.

Example 9 can include, or can optionally be combined with the subject matter of Examples 1-8 to optionally include wherein the aerogel insulating layer includes one or more of crosslinked aerogel, fiber-reinforced aerogel, vapor deposition reinforced aerogel, polyimide aerogel or aerogel slats.

Example 10 can include, or can optionally be combined with the subject matter of Examples 1-9 to optionally include wherein the pliable substrate film is impermeable to at least water.

Example 11 can include, or can optionally be combined with the subject matter of Examples 1-10 to optionally include a method of making a thermal insulating construction wrap comprising: layering a pliable substrate film with an aerogel insulating layer, the pliable substrate film is resistant to at least water; and bonding the pliable substrate film with the aerogel insulating layer, bonding comprising: feeding the layered pliable substrate film and aerogel insulating layer toward a compressive nip, and compressing the layered pliable substrate film and aerogel insulating layer together with the compressive nip.

Example 12 can include, or can optionally be combined with the subject matter of Examples 1-11 to optionally include heating one or more of the pliable substrate film or the aerogel insulating layer.

Example 13 can include, or can optionally be combined with the subject matter of Examples 1-12 to optionally include wherein heating is before bonding.

Example 14 can include, or can optionally be combined with the subject matter of Examples 1-13 to optionally include wherein heating is during bonding.

Example 15 can include, or can optionally be combined with the subject matter of Examples 1-14 to optionally include wherein compressing the layered pliable substrate film and aerogel insulating layer together includes infiltrating the aerogel insulating layer with the pliable substrate film.

Example 16 can include, or can optionally be combined with the subject matter of Examples 1-15 to optionally include wherein compressing the layered pliable substrate film and aerogel insulating layer together includes rolling the layered pliable substrate and aerogel insulating layer between opposed compressive rollers having the compressive nip.

Example 17 can include, or can optionally be combined with the subject matter of Examples 1-16 to optionally include applying an adhesive between the pliable substrate film and the aerogel insulating layer.

Example 18 can include, or can optionally be combined with the subject matter of Examples 1-17 to optionally include wherein layering the pliable substrate film with the aerogel insulating layer includes layering the pliable substrate film with a plurality of aerogel slats.

Example 19 can include, or can optionally be combined with the subject matter of Examples 1-18 to optionally include wherein layering the pliable substrate film with the aerogel insulating layer includes layering the pliable substrate film with the aerogel insulating layer including a storage membrane having aerogel filler in a plurality of storage cells.

Example 20 can include, or can optionally be combined with the subject matter of Examples 1-19 to optionally include wherein the pliable substrate film includes an exterior substrate film and an interior substrate film, and layering the pliable substrate film with the aerogel insulating layer includes: layering exterior substrate film with the aerogel insulating layer, and layering the interior substrate film with the aerogel insulating layer, the aerogel insulating layer between the exterior and interior substrate films.

Example 21 can include, or can optionally be combined with the subject matter of Examples 1-20 to optionally include wherein the aerogel insulating layer includes aerogel slats, and compressing the layered pliable substrate film and aerogel insulating layer together includes: compressing the exterior and interior substrate films together between the aerogel slats, and forming storage cells with the exterior and interior substrate films, and the aerogel slats are within the storage cells.

Each of these non-limiting examples can stand on its own, or can be combined in various permutations or combinations with one or more of the other examples.

The above detailed description includes references to the accompanying drawings, which form a part of the detailed description. The drawings show, by way of illustration, specific embodiments in which the disclosure can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the disclosure should be determined with reference to the appended claims, along with the fill scope of equivalents to which such claims are entitled.

The claimed inventions is:

1. A thermal insulating construction wrap comprising:
a pliable substrate film, the pliable substrate film is resistant to at least water penetration, and the pliable substrate film includes:
an exterior face, and
an interior face;
an aerogel insulating layer coupled along the interior face of the pliable substrate film; and
wherein the thermal insulating construction wrap is pliable.

2. The wrap of claim 1 comprising an adhesive layer interposed between the interior face and the aerogel insulating layer.

3. The wrap of claim 1, wherein the pliable substrate film infiltrates the aerogel insulating layer to couple the aerogel insulating layer with the pliable substrate film.

4. The wrap of claim 3, wherein the pliable substrate film infiltrates pores of the aerogel insulating layer.

5. The wrap of claim 1, wherein the aerogel insulating layer includes a plurality of aerogel slats, and the plurality of aerogel slats are coupled along the interior face of the pliable substrate film with one or more of scoring or slits between each of the aerogel slats.

6. The wrap of claim 1, wherein the aerogel insulating layer includes:
a storage membrane including a plurality of storage cells, the storage membrane coupled along the interior face of the pliable substrate film, and
aerogel filler within the storage cells of the plurality of storage cells.

7. The wrap of claim 1, wherein the pliable substrate film includes:
a storage membrane including a plurality of storage cells between the exterior and interior faces, and
the aerogel insulating layer includes aerogel filler within the storage cells of the plurality of storage cells.

8. The wrap of claim 1, wherein the pliable substrate film includes one or more of thermoplastic polyolefin, laminate of woven polypropylene, high density polyethylene (HDPE), spunbond HDPE, micro-perforated and cross-lapped films, films laminated to spunbond nonwovens, films laminated or coated to polypropylene wovens, supercalendered wetlaid polyethylene fibril nonwoven, reflective aluminum foil, cross-linked polymer films, a layer of rubberized asphalt, or composites of polymers and recycled materials.

9. The wrap of claim 1, wherein the aerogel insulating layer includes one or more of crosslinked aerogel, fiber-reinforced aerogel, vapor deposition reinforced aerogel, polyimide aerogel or aerogel slats.

10. The wrap of claim 1, wherein the pliable substrate film is impermeable to at least water.

11. A method of making a thermal insulating construction wrap comprising:
layering a pliable substrate film with an aerogel insulating layer, the pliable substrate film is resistant to at least water; and
bonding the pliable substrate film with the aerogel insulating layer, bonding comprising:
feeding the layered pliable substrate film and aerogel insulating layer toward a compressive nip, and
compressing the layered pliable substrate film and aerogel insulating layer together with the compressive nip.

12. The method of claim 11 comprising heating one or more of the pliable substrate film or the aerogel insulating layer.

13. The method of claim 12, wherein heating is before bonding.

14. The method of claim 12, wherein heating is during bonding.

15. The method of claim 11, wherein compressing the layered pliable substrate film and aerogel insulating layer together includes infiltrating the aerogel insulating layer with the pliable substrate film.

16. The method of claim 11, wherein compressing the layered pliable substrate film and aerogel insulating layer together includes rolling the layered pliable substrate and aerogel insulating layer between opposed compressive rollers having the compressive nip.

17. The method of claim 11 comprising applying an adhesive between the pliable substrate film and the aerogel insulating layer.

18. The method of claim 11, wherein layering the pliable substrate film with the aerogel insulating layer includes layering the pliable substrate film with a plurality of aerogel slats.

19. The method of claim 11, wherein layering the pliable substrate film with the aerogel insulating layer includes layering the pliable substrate film with the aerogel insulating layer including a storage membrane having aerogel filler in a plurality of storage cells.

20. The method of claim 11, wherein the pliable substrate film includes an exterior substrate film and an interior substrate film, and layering the pliable substrate film with the aerogel insulating layer includes:
layering the exterior substrate film with the aerogel insulating layer, and
layering the interior substrate film with the aerogel insulating layer, the aerogel insulating layer between the exterior and interior substrate films.

21. The method of claim 20, wherein the aerogel insulating layer includes aerogel slats, and compressing the layered pliable substrate film and aerogel insulating layer together includes:
compressing the exterior and interior substrate films together between the aerogel slats, and
forming storage cells with the exterior and interior substrate films, and the aerogel slats are within the storage cells.
